(19) United States
(12) Patent Application Publication
(10) Pub. No.: US 2026/0200556 A1
(43) Pub. Date: Jul. 16, 2026

(54) METHOD FOR TRANSPORTING HYDROGEN FROM A FLOATING WIND TURBINE TO A WATERCRAFT

(71) Applicant: CRUSE Offshore GmbH, Hamburg (DE)

(72) Inventor: Jens Cruse, Hamburg (DE)

(73) Assignee: CRUSE Offshore GmbH, Hamburg (DE)

(21) Appl. No.: 19/132,204

(22) PCT Filed: Nov. 28, 2023
(86) PCT No.: PCT/EP2023/083342

§ 371 Date: May 22, 2025

(30) Foreign Application Priority Data
Nov. 29, 2022 (EP) 22210163.6

(51) Int. Cl. B63B 27/34; F03D 9/19; F03D 13/25

(52) U.S. Cl. CPC B63B 27/34; F03D 9/19; F03D 13/256; F05B 2220/61

(57) ABSTRACT

A method (100) for transporting hydrogen from a floating wind turbine (10) to a watercraft (11) is proposed in order to transport environmentally friendly energy generated by an offshore wind turbine from the offshore wind turbine to land in a simple and safe manner, wherein hydrogen is provided in a holding tank (31) of a floating wind turbine (10), wherein a watercraft (11) with a transportation tank (36) is positioned at the floating wind turbine (10), wherein the hydrogen is conveyed from the holding tank (31) to the transportation tank (36) by means of a line (35) configured to convey the hydrogen.

The present invention relates to a method of transporting hydrogen from a floating wind turbine to a watercraft. Furthermore, the present invention relates to a floating wind turbine.

### TECHNOLOGICAL BACKGROUND

Offshore wind turbines known from prior art are erected as wind farms in the foreshore of the oceans. Massive foundation structures are provided to anchor such offshore wind turbines to the seabed. The electricity generated by offshore wind turbines is transported to a transfer station on land using export cables designed for this purpose.

Anchoring offshore wind turbines to the seabed by means of foundation structures restricts the suitable geographical areas of application to the offshore areas. In addition, the laying and maintenance of export cables is complex and cost-intensive.

U.S. Pat. No. 11,391,261 B2 discloses a system and a method for converting energy from ocean waves into hydrogen. At least part of the hydrogen gas generated is transferred to a transport ship.

EP 3 339 634 A1 discloses a method for producing fuels in which an electrolysis of seawater is first carried out on floating bodies moving autonomously on the sea with the aid of natural energy sources, and the resulting hydrogen is physically or chemically bound in order to use it as fuel itself or to process it further into fuels by means of chemical methods known per se.

DE 10 2021 000 091 A1 discloses a modular wind power and refining plant on floating bodies with flying kites for harvesting high-altitude wind with a linear trajectory and continuous power development and integrated further processing into transportable energy carriers.

### DESCRIPTION OF THE INVENTION: TASK, SOLUTION, ADVANTAGES

The present invention is based on the task of transporting environmentally friendly energy generated by an offshore wind turbine from the offshore wind turbine to land in a simple and safe manner. Furthermore, the present invention is based on the task of providing an offshore wind turbine by means of which energy can be generated and which can also be used outside the coastal regions.

To solve the problem underlying the invention, a method for conveying hydrogen from a floating wind turbine to a watercraft is proposed, wherein hydrogen is provided in a holding tank of a floating wind turbine, wherein a watercraft with a transport tank is positioned at the floating wind turbine, and wherein the hydrogen is conveyed from the holding tank to the transport tank by means of a line configured to convey the hydrogen.

In the method according to the invention, hydrogen provided in a holding tank of a floating wind turbine is thus transported from the floating wind turbine to a watercraft, for example to a ship or a tanker or tanker vessel. The hydrogen can be present in unbound form or in a form bound in a carrier medium.

Unlike in the prior art, the electricity generated by the wind turbine is therefore not transported to a transfer station on land via submarine export cables. Rather, as will be explained in more detail below, the electricity generated by the wind turbine can be used to produce the hydrogen. The floating wind turbine provided in the method thus serves preferably to produce environmentally friendly “green” hydrogen.

According to the invention, in the proposed method it is not provided that the hydrogen provided in the holding tank is transported to land via submarine lines or pipelines. In particular, there are no submarine lines or pipelines present. Instead, according to the invention, it is provided that the hydrogen provided in a holding tank in the floating wind turbine is transported by means of a line provided for this purpose into the transport tank of a watercraft positioned near the floating wind turbine, for example a ship or tanker. The hydrogen can then be transported ashore by means of the watercraft, in particular the ship or tanker.

The wind turbine used in the method is a floating wind turbine which is not fixed to the seabed, in particular by means of known solid foundation structures. Preferably, the floating wind turbine is merely anchored to the seabed with hawsers or anchoring ropes, as will be explained below, allowing the floating wind turbine to move.

The floating design of the wind turbine has the advantage that the wind turbine can react to the sea state and the prevailing wind conditions, in particular wind force and wind direction, and can align itself independently.

With further advantage, it can be provided that the line is connected directly or indirectly to the holding tank and/or the transport tank, and/or that the line is a hose line or a pipeline.

If several lines are provided, the line configured for transporting the hydrogen can also be referred to as the first line.

In the case of an indirect connection with the holding tank and/or the transport tank, pumps or valves or pipe systems can be provided on board the watercraft or on the floating wind turbine in order to convey the hydrogen transported through the line into the transport tank of the watercraft. It is essential that hydrogen provided in the holding tank of the floating wind turbine is conveyed into the ship's transport tank by means of the line.

The line is in particular a hose line or a pipeline and further in particular a flexible hose line or pipeline. The flexibility of the hose line or pipeline makes it possible to compensate for relative movements between the watercraft and the floating wind turbine in rough seas and/or wind without the risk of the line becoming detached from the watercraft and/or the wind turbine.

It is also preferable that the hydrogen is molecular hydrogen H₂.

It may be particularly preferred that a liquid carrier medium enriched with the hydrogen is provided in the holding tank, and that the enriched carrier medium comprising the hydrogen is conveyed from the holding tank to the transport tank by means of the line, wherein the liquid carrier medium is preferably a liquid organic hydrogen carrier (LOHC).

A liquid carrier medium enriched with hydrogen is easy to store and transport. Furthermore, such carrier media are difficult to ignite. The carrier medium can also be reusable.

Liquid organic hydrogen carriers (LOHC) are organic compounds that can absorb and release hydrogen through a chemical reaction. To absorb hydrogen, a dehydrated form of the LOHC that is not enriched with hydrogen reacts with the hydrogen in a hydrogenation reaction. Hydrogenation is an exothermic reaction and is carried out at elevated pressures (approx. 30 to 50 bar) and temperatures of approx. 150° C. to 200° C. in the presence of a catalyst. If the hydrogen is needed again, the now hydrogenated, hydrogen-enriched form of the LOHC is dehydrogenated, wherein the hydrogen is released from the LOHC again. This release reaction is endothermic and takes place at elevated temperatures (250° C. to 320° C.) again in the presence of a catalyst. Before the hydrogen can be used, it may need to be purified from LOHC vapor.

In principle, it is also possible for the hydrogen to be stored in gaseous form at a high pressure of 200 to 700 bar or in a liquid state at very low temperatures of −253° C. and transported from the floating wind turbine to the transport tank of the watercraft. However, it is preferably provided that the hydrogen is absorbed by the liquid carrier medium and that the liquid carrier medium enriched with hydrogen is then provided in the holding tank of the floating wind turbine.

Furthermore, a second line can preferably be provided, wherein during the transportation of the enriched carrier medium from the holding tank to the transport tank, a non-enriched carrier medium is simultaneously transported from the watercraft to a supply tank of the floating wind turbine.

In other words, there is then another tank in the watercraft, e.g. a storage tank, in which a dehydrated carrier medium that is not enriched with hydrogen is stored. Via a second line, which is provided separately from the first line, a non-enriched carrier medium can then be transported from the storage tank of the watercraft to the supply tank of the floating wind turbine at the same time as the enriched carrier medium is transported from the holding tank to the transport tank. The supply tank of the floating wind turbine is preferably a supply tank which is separate from the holding tank. The dehydrated, unenriched liquid carrier medium provided in this way in the supply tank of the floating wind turbine can be reused on the wind turbine to absorb hydrogen and provide it in the holding tank.

It is preferable that the wind turbine has a device for generating hydrogen and/or that the wind turbine has a device for enriching a liquid carrier medium with hydrogen.

Preferably, the device for generating hydrogen comprises a seawater treatment plant for providing distilled water, wherein the seawater treatment plant comprises an evaporator and a condenser, and/or an electrolyser for water electrolysis, and/or preferably the device for enriching a liquid carrier medium with hydrogen comprises a hydrating device.

All the devices required for producing the hydrogen or the liquid carrier medium enriched with hydrogen can therefore be provided on the floating wind turbine.

It is preferably provided that the hydrogen provided in the holding tank is produced by means of the device for producing hydrogen, and/or that the liquid carrier medium enriched with the hydrogen provided in the holding tank is produced by means of the device for enriching a liquid carrier medium with hydrogen.

It may be provided that the electricity generated by the floating wind turbine is used for operating the seawater treatment plant, in particular the evaporator and/or condenser, and/or for operating the electrolyser. However, it is preferred that waste heat from other processes and cooling water are used for operating the seawater treatment plant, in particular the evaporator and/or condenser. In particular, it is preferably provided that the heat generated in the exothermic hydrogenation reaction of the dehydrated LOHC with the hydrogen and/or the waste heat generated during operation of the electrolyser is used for operating the evaporator. The heat from the hydrogenation reaction and/or the waste heat from the electrolyser can be fed to the seawater treatment plant by means of a heat transfer medium, in particular by means of cooling water. It is also preferable to use cooling water from other processes or seawater for operating the condenser. Liquid cooling, in particular water cooling, is thus preferably used for cooling the electrolyser and/or the hydrating device. It is further preferred that no air cooling is used. Seawater can be distilled by means of the evaporator and the condenser and thus freed from salts and minerals. The distilled water can then be broken down into hydrogen and oxygen using the electrolyser, which is preferably powered by the electricity generated by the wind turbine. The hydrogen obtained in this way can be provided in gaseous or liquid form in the holding tank, as described above. However, it is preferable that the liquid carrier medium is enriched with the hydrogen obtained by means of the hydrogenation device. The liquid carrier medium enriched with the hydrogen is then provided in the holding tank of the floating wind turbine.

With further advantage, it can be provided that the, preferably first, line and/or the second line is arranged load-free between the wind turbine and the watercraft, wherein the watercraft is preferably attached to the wind turbine by means of a hawser and/or a bow line

A load-free arrangement of the first line and/or the second line is understood here to mean that the first line and/or the second line does not absorb any holding forces required for fastening and positioning the watercraft at the wind turbine. Loads on the first line and/or the second line are preferably only caused by their own weight or by the weight of the hydrogen and/or liquid carrier medium transported therein.

In particular, the lines are not used for fastening or positioning the watercraft at the wind turbine. Rather, it may be provided that the watercraft is attached to the wind turbine by means of a hawser and/or a bow line. The hawser and/or bow line of the watercraft then serves to fasten and position the watercraft relative to the wind turbine. The hawser and/or bow line preferably absorbs all the forces required to hold and position the watercraft.

The, preferably flexible, first line and/or the second line can be fastened in a sagging way between the watercraft and the floating wind turbine. Relative movements between the watercraft and the floating wind turbine can thus be compensated for.

It may also be provided that the first line and/or the second line is suspended from the hawser and/or the bow line of the watercraft.

It is preferable that the wind turbine is a self-aligning wind turbine, wherein the wind turbine is preferably anchored to a seabed with at least one, more preferably three, mooring ropes and/or anchoring ropes. Furthermore, especially at great water depths of, for example, 1,000 m and more, it is possible to connect several floating wind turbines to each other by means of mooring ropes. The floating wind turbines connected in this way form a net, so to speak, which is preferably anchored to the seabed at the edge.

In other words, the floating wind turbine is anchored to the seabed in such a way that it can align itself independently according to the wind and/or the swell. This ensures that the wind turbine is always optimally positioned or aligned with the prevailing wind direction.

For this purpose, it may be provided that the wind turbine comprises a single-point mooring device, in particular a single-point mooring buoy.

The single-point mooring device or the single-point mooring buoy can also be referred to as a tower buoy. Advantageously, the single-point mooring device or the single-point mooring buoy is configured in such a way that the wind turbine can rotate around it, comparable to a weather vane.

The mooring ropes and/or anchoring ropes can preferably be attached to the single-point mooring device or to the single-point mooring buoy. In other words, the floating wind turbine can rotate around the single-point mooring device or the single-point mooring buoy without twisting the mooring ropes and/or anchoring ropes.

It is preferably provided that the watercraft, in particular the ship or tanker, is attached to the downwind side, or the leeward side, of the floating wind turbine.

Furthermore, it may preferably be provided that the watercraft, in particular while the enriched carrier medium comprising the hydrogen is conveyed from the holding tank to the transport tank by means of the first line configured for conveying the hydrogen and/or while the non-enriched carrier medium is conveyed from the watercraft to the supply tank of the floating wind turbine, follows an orientation of the floating wind turbine during wind rotations, in particular passively. In particular, this can mean that the drive of the watercraft is not used to maintain a relative position with respect to the floating wind turbine.

As explained above, the watercraft can be attached to the floating wind turbine by means of a hawser and/or a bow line of the watercraft, wherein further preferably the first line and/or the second line are suspended from the hawser and/or the bow line of the watercraft.

With particular advantage, it can then be provided that the watercraft aligns itself with the wind. In particular, the watercraft assumes a stable position and follows the orientation of the floating wind turbine even when the wind shifts. The hydrogen or the liquid carrier medium enriched with the hydrogen can then be conveyed from the holding tank to the transport tank even in rough seas by means of the first line configured to convey the hydrogen or the liquid carrier medium enriched with the hydrogen. In addition, in a preferred embodiment, in particular simultaneously with the transportation of the enriched carrier medium from the holding tank to the transport tank, a non-enriched carrier medium can be transported from the watercraft to a supply tank of the floating wind turbine by means of the second line.

With further advantage, it may be provided that the wind turbine comprises a support mast and a rotor arranged at the support mast, wherein the support mast has a symmetrical or asymmetrical airfoil profile.

The configuration of the support mast with a symmetrical or asymmetrical airfoil profile favors the self-alignment of the floating wind turbine.

The support mast or a rotor nacelle arranged on it can also have a generator connected to the rotor.

It is preferably provided that the rotor nacelle is firmly connected to the support mast and, in particular, cannot be rotated around the support mast.

It is particularly advantageous if the floating wind turbine is a self-aligning wind turbine and if the watercraft is attached to the floating wind turbine by means of a hawser or bow line.

This makes it particularly easy to keep the watercraft stable in approximately the same position as the wind turbine.

In an exemplary mooring maneuver, the watercraft can be driven up to the floating wind turbine with the bow against the wind direction, wherein the position of the rudder blade and the thrust of the propeller can preferably compensate for drifting movements of the watercraft. Once a hawser or bow line has been taken over and attached to the floating wind turbine, the watercraft drifts in the direction of the wind until the holding force of the hawser or bow line stops this drifting movement. This achieves a state that corresponds to the stability of an anchored watercraft and no further active maneuvering is required. The watercraft then aligns itself automatically with the wind and/or swell together with the floating wind turbine. Further, it may be provided that the wind turbine has a support unit, in particular a float unit, wherein the support unit has ballast units and/or buoyancy units, wherein the support unit is preferably configured as a semi-submersible.

The configuration of the support unit as a semi-submersible is particularly advantageous here. As a result of the support unit lying deep in the water, the swell only has a minor influence on the alignment and stability of the wind turbine.

Preferably, the support mast comprising the rotor is arranged on one of the buoyancy units.

With further advantage, it may be provided that the support unit comprises at least three, preferably four, buoyancy units, wherein the buoyancy units are arranged in at least almost the corners of a triangular or a quadrangular, in particular diamond-shaped, ground plan, wherein preferably one of the ballast units extends between two of the buoyancy units.

It is particularly preferred that one of the ballast units extends between two of the buoyancy units.

After transportation or transfer of the hydrogen or the hydrogen-enriched liquid carrier medium from the holding tank of the wind turbine to the transport tank of the watercraft, the watercraft can travel to the next floating wind turbine and pick up hydrogen or the enriched liquid carrier medium and/or deliver dehydrated, unenriched liquid carrier medium to the floating wind turbine using the same method. If the capacity of the watercraft's transport tank(s) is exhausted, the watercraft can then travel to a port or to another watercraft to unload the cargo and/or exchange the hydrogen-enriched liquid carrier medium for non-enriched liquid carrier medium. The cycle then starts again.

A further solution to the problem underlying the invention consists in a floating wind turbine for a method as described above, comprising a device for generating hydrogen and/or comprising a device for enriching a liquid carrier medium with hydrogen.

The wind turbine according to the invention can be configured in accordance with the floating wind turbine used in the method described above.

In particular, it may be provided that the wind turbine is a self-aligning wind turbine, and/or that the wind turbine can be anchored or is anchored to a seabed with at least one, more preferably with three, mooring ropes and/or anchoring ropes, and/or that the wind turbine comprises a single point mooring device, in particular a single point mooring buoy, and/or that the wind turbine comprises a support mast and a rotor arranged at the support mast, wherein the support mast has a symmetrical or asymmetrical airfoil profile.

### BRIEF DESCRIPTION OF THE FIGURES

The invention is explained in more detail below with reference to the attached figures. They show

FIG. 1 a perspective view of a floating wind turbine with a watercraft positioned nearby,

FIG. 2 another perspective view of a floating wind turbine with a watercraft positioned nearby,

FIG. 3 a support unit of the floating wind turbine,

FIG. 4 a schematic diagram of a method for transporting hydrogen from a floating wind turbine to a watercraft, and

FIG. 5 a flow chart of the process for transporting hydrogen from a floating wind turbine to a watercraft.

### DETAILED DESCRIPTION OF THE FIGURES

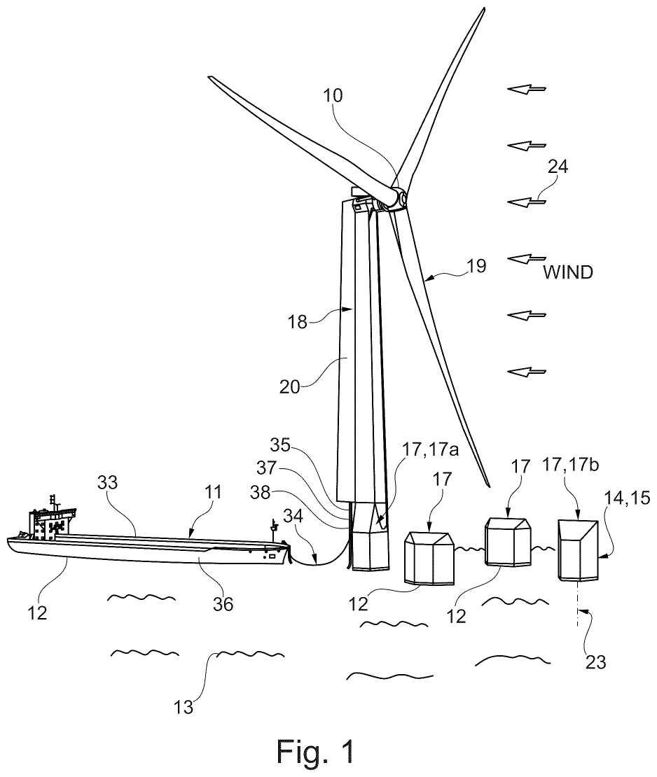

With reference to FIGS. 1 to 5, a method 100 for transporting hydrogen from a floating wind turbine 10 to a watercraft 11 is described.

FIG. 1 shows a floating wind turbine 10 and a watercraft 11 positioned next to the floating wind turbine 10 In FIG. 1, the floating wind turbine 10 and the watercraft 11 are shown floating, as indicated by the water lines 12 on the floating wind turbine 10 and on the watercraft 11, so that parts of the floating wind turbine 10 and the watercraft 11 are below the water surface 13.

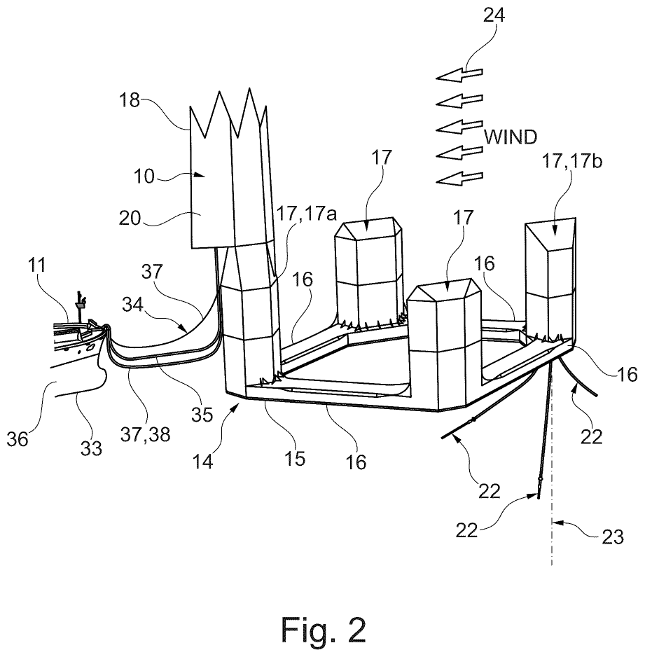

FIG. 2 shows the arrangement shown in FIG. 1 from a different perspective, but without the water surface 13.

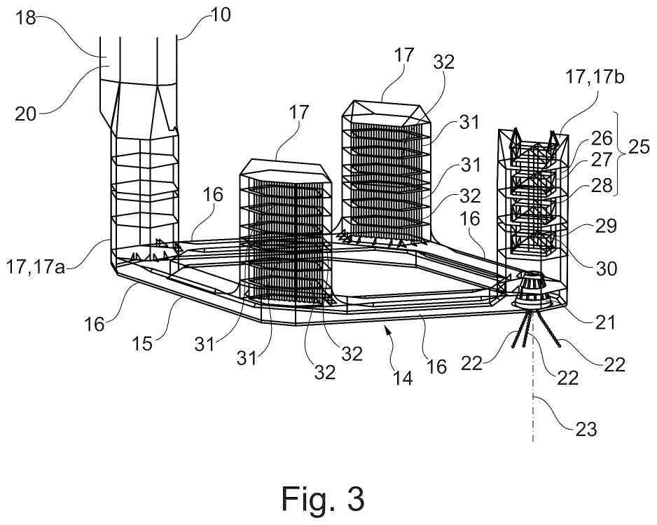

FIG. 3 shows a perspective, schematic view of a support unit 14 of the floating wind turbine 10. The support unit 14 of the floating wind turbine 10 is configured as a semi-submersible 15 and has ballast units 16 and buoyancy units 17. One of the ballast units 16 is arranged between every two buoyancy units 17. The four buoyancy units 17 are arranged at the corners of a quadrangular and diamond-shaped ground plan of the support unit 14. As can be seen in particular from FIG. 1, the ballast units 16 are largely located below the water surface 13 in the case of the carrying unit 14 configured as a semi-submersible 15 when it is arranged in the water, whereas the buoyancy units 17 are arranged at least partially above the water surface 13. A support mast 18 of the floating wind turbine 10 with a rotor 19 arranged thereon is arranged on a first buoyancy unit 17a. The support mast 18 has an airfoil profile 20. A single-point mooring device 21 is arranged in a second buoyancy unit 17b. Three hawsers or anchoring ropes 22 are provided on the single-point mooring device 21, by means of which the support unit 14 or the floating wind turbine 10 can be anchored to the seabed. The entire support unit 14 or wind turbine 10 can rotate freely around an axis of rotation 23 running through the single-point mooring device 21. This free rotation allows the floating wind turbine 10 to self-align with the prevailing wind 24 or the water current. The self-alignment is significantly supported by the airfoil profile 20 of the support mast 18.

A device 25 for generating hydrogen, comprising a seawater treatment plant 39 with an evaporator 26 and a condenser 27 for producing distilled water 40 and an electrolyser 28 for water electrolysis, and a device 29 for enriching a liquid carrier medium with hydrogen, comprising a hydrogenation device 30, are arranged in the buoyancy units 17.

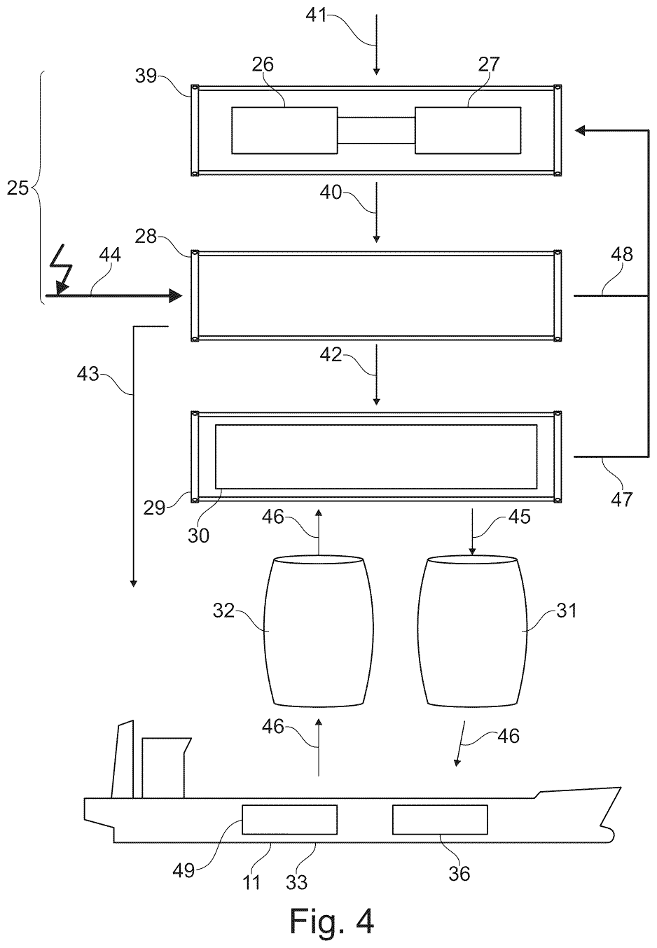

As shown in FIG. 4, seawater 41 is first fed to the seawater treatment plant 39, which distils it by means of the evaporator 26 and the condenser 27. The distilled water 40 is then split into hydrogen 42 and oxygen 43 by means of the electrolyser 28, wherein the electricity 44 generated by the wind turbine 10 is used for operating the electrolyser 28. In the hydrogenation device 30, the hydrogen 42 obtained in this way is combined in a chemical reaction with a liquid carrier medium, for example LOHC. The hydrogen-enriched liquid carrier medium 45 generated in this way is provided in holding tanks 31 in the buoyancy units 17. Furthermore, supply tanks 32 are provided in the buoyancy units 17, in which dehydrated, unenriched liquid carrier medium 46 is kept in order to enrich it with the hydrogen 42 obtained in the hydrogenation device 30. The electric current 44 obtained by the wind turbine 10 can also be used for operating the seawater treatment plant 39. Alternatively or additionally, as shown in FIG. 4, the heat 47 from the hydrogenation reaction in the hydrogenation device 30 and the waste heat 48 from the electrolyser 28 can be used for operating the seawater treatment plant 39.

In order to transport the liquid carrier medium 45 enriched with the hydrogen, as shown in FIGS. 1, 2 and 4, a watercraft 11, in particular a tanker vessel 33, is positioned at the floating wind turbine 10, preferably on the downwind side or the leeward side of the floating wind turbine 10. The watercraft 11 is connected to the floating wind turbine 10 by means of a hawser or bow line 34. The watercraft 11 can then drift in the direction of the wind until the holding force of the bow line 34 stops this movement. The watercraft 11 then aligns itself with the wind 24 together with the floating wind turbine 10. In particular, this means that the watercraft 1011 assumes a stable position and follows the orientation of the floating wind turbine 10 even when the wind shifts. A first line 35 for transporting the hydrogen-enriched liquid carrier medium 45 from the holding tanks 31 of the floating wind turbine 10 to a transport tank 36 provided in the watercraft 11 is connected to the watercraft 11 and the floating wind turbine 10. The first line 35 is a flexible hose line 37, which runs between the floating wind turbine 10 and the watercraft 11 in a substantially load-free suspended manner. All the forces required for holding the watercraft 11 are absorbed by the bow line 34. Relative movements between the watercraft 11 and the floating wind turbine 10 are made possible by the flexibility and sagging of the first line 35. After the watercraft 11 is connected to the floating wind turbine 10, the hydrogen-enriched liquid carrier medium 45 provided in the holding tanks 31 of the floating wind turbine 10 is transported from the holding tanks 31 to the transport tank 36 of the watercraft 11. A second line 38, which is also kept load-free, is provided in order to simultaneously convey a dehydrated, unenriched liquid carrier medium 46 from a storage tank 49 of the watercraft 11 into the support tanks 32 of the floating wind turbine 10 while the hydrogen-enriched carrier medium 45 is being conveyed from the holding tanks 31 into the transport tank 36. The dehydrated, non-enriched liquid carrier medium 46 thus provided in the supply tanks 32 is then intended for renewed enrichment with hydrogen 42 by means of the hydrogenation device 30. After the hydrogen-enriched liquid carrier medium 45 provided in the holding tanks 31 has been transported into the transport tank 36 of the watercraft 11, the watercraft 11 can, if there is still capacity in the transport tank 36, move to a further floating wind turbine 10, not shown, and carry out the process again, i.e. the exchange of the enriched liquid carrier medium 45 with the non-enriched liquid carrier medium 46.

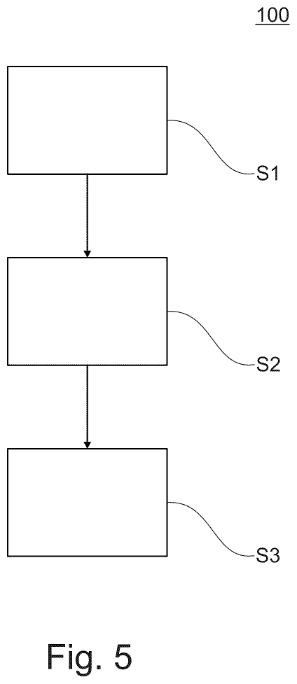

FIG. 5 shows a flowchart of a method 100 for transporting hydrogen from a floating wind turbine 10 to a watercraft 11. In a first step S1, hydrogen 42 or a hydrogen-enriched liquid carrier medium 45 is provided in a holding tank 31 of a floating wind turbine 10. In a second method step S2, a watercraft 11 with a transport tank 36 is positioned at the floating wind turbine 10. In a third method step S3, the hydrogen 42 or the hydrogen-enriched liquid carrier medium 45 is conveyed from the holding tank 31 into the transport tank 36 by means of a line 35 configured to convey the hydrogen.

### LIST OF REFERENCE SIGNS

100 Method
10 Floating wind turbine
11 Watercraft
12 Waterline
13 Water surface
14 Support unit
15 Semi-submersible
16 Ballast unit
17 Buoyancy unit
17a First buoyancy unit
17b Second buoyancy unit
18 Support mast
19 Rotor
20 Airfoil profile
21 Single-point mooring device
22 Anchoring rope
23 Axis of rotations
24 Wind
25 Device for producing hydrogen
26 Vaporizer
27 Capacitor
28 Electrolyser
29 Device for enriching a liquid carrier medium with Hydrogen
30 Hydrogenation device
31 Holding tank
32 Supply tank
33 Tanker vessel
34 Bow line
35 Line
36 Transport tank
37 Hose line
38 Line
39 Seawater treatment plant
40 Distilled water
41 Seawater
42 Hydrogen
43 Oxygen
44 Electric current
45 Enriched liquid carrier medium
46 Non-enriched liquid carrier medium
47 Heat
48 Waste heat
49 Storage tank
S1 Method step
S2 Method step
S3 Method step

1. A method for transporting hydrogen from a floating wind turbine to a watercraft, wherein a liquid carrier medium enriched with hydrogen is provided in a holding tank of a floating wind turbine, wherein a watercraft with a transport tank is positioned at the floating wind turbine, wherein the enriched carrier medium comprising the hydrogen is conveyed from the holding tank into the transport tank by means of a first line configured to convey the hydrogen, wherein the liquid carrier medium is a liquid organic hydrogen carrier, wherein a second line is provided, wherein during the transportation of the enriched carrier medium from the holding tank to the transport tank, a non-enriched carrier medium is simultaneously transported from the watercraft to a support tank of the floating wind turbine, wherein the wind turbine is a self-aligning wind turbine, wherein the wind turbine is being or is anchored to a seabed with at least one of a mooring rope or an anchoring rope, and wherein the wind turbine comprises a single point mooring device.

2. The method according to claim 1, wherein the first line is connected directly or indirectly to the holding tank and the transport tank, wherein the first line is a hose line or a pipeline.

3. The method according to claim 1, wherein the wind turbine has at least one of a device for generating hydrogen or a device for enriching a liquid carrier medium with hydrogen.

4. The method according to claim 3, wherein the device for generating hydrogen comprises at least one of an evaporator and a condenser for providing distilled water or an electrolyser for water electrolysis.

5. The method according to claim 3, wherein the liquid carrier medium enriched with the hydrogen provided in the holding tank is produced by means of the device for enriching a liquid carrier medium with hydrogen.

6. The method according to claim 1, wherein at least one of the first line and/or the second line is arranged load-free between the wind turbine and the watercraft, wherein the watercraft is attached to the wind turbine by means of at least one of a hawser or a bow line.

7. The method according to claim 1, wherein the wind turbine is being or is anchored to the seabed by at least three mooring ropes or anchoring ropes.

8. The method according to claim 1, wherein the wind turbine comprises a support mast and a rotor arranged at the support mast, wherein the support mast has a symmetrical or asymmetrical support blade profile.

9. The method according to claim 1, wherein the wind turbine has a support unit, wherein the support unit has ballast units and buoyancy units wherein the support unit is configured as a semi-submersible.

10. The method according to claim 9, wherein at least one of the device for generating hydrogen or the device for enriching a liquid carrier medium with hydrogen are arranged in at least one of the ballast units or buoyancy units.

11. The method according to claim 9, wherein the support unit comprises at least three or four buoyancy units wherein the buoyancy units are arranged in at least almost the corners of a triangular or a quadrangular ground plan, wherein one of the ballast units extends between two of the buoyancy units.

12. A floating wind turbine for the method according to claim 1, comprising at least one of a device for generating hydrogen or a device for enriching a liquid carrier medium with hydrogen.

13. The floating wind turbine according to claim 12, wherein the wind turbine is a self-aligning wind turbine, wherein the wind turbine is anchorable or anchored to a seabed by at least one or three mooring ropes or anchoring ropes, and wherein the wind turbine comprises a single point mooring device, and wherein the wind turbine comprises a support mast and a rotor arranged on the support mast, wherein the support mast has a symmetrical or asymmetrical airfoil profile.

14. The method according to claim 3, wherein the device for enriching a liquid carrier medium with hydrogen comprises a hydrogenation device.

15. The method according to claim 1, wherein the single point mooring device comprises a single point mooring buoy.

16. The method according to claim 9, wherein the support unit is a float unit.

17. The method according to claim 11, wherein the ground plan is diamond-shaped.

18. The floating wind turbine according to claim 13, wherein the single point mooring device is a single point mooring buoy.
